(19) United States
(12) Patent Application Publication
(10) Pub. No.: US 2012/0166585 A1
(43) Pub. Date: Jun. 28, 2012

(54) APPARATUS AND METHOD FOR ACCELERATING VIRTUAL DESKTOP

(75) Inventors: Dae-Won KIM, Daejeon (KR); Sun-Wook Kim, Hwanseong (KR); Hak-Jae Kim, Daejeon (KR); Seong-Woon Kim, Gyeryong (KR)

(73) Assignee: Electronics and Telecommunications Research Institute, Daejeon (KR)

(21) Appl. No.: 13/335,764

(22) Filed: Dec. 22, 2011

(30) Foreign Application Priority Data
Dec. 23, 2010 (KR) 10-2010-0133946

(51) Int. Cl. G06F 15/16

(52) U.S. Cl. 709/217

(57) ABSTRACT

Disclosed herein is an apparatus for accelerating a virtual desktop, including: a plurality of media processors, processing media data; a processor, extracting data attribute information from virtual desktop acceleration commands for a client apparatus received from a host apparatus and transmitting the virtual desktop acceleration commands to any one of the plurality of media processors according to the attribute information; a transmission unit, transmitting processed results for the virtual desktop acceleration commands, processed through the plurality of media processors, to the client apparatus; and a transmission command pool, transmitting a complete signal, indicating that the processed results have been transmitted to the client apparatus, to the host apparatus.

### CROSS-REFERENCE(S) TO RELATED APPLICATIONS

This application claims priority to Korean Patent Application No. 10-2010-0133946, filed on Dec. 23, 2010, which is incorporated herein by reference in its entirety.

### BACKGROUND OF THE INVENTION

1. Field of the Invention

Exemplary embodiments relate to an apparatus and a method for accelerating a virtual desktop and, particularly, to an apparatus and a method for accelerating a virtual desktop that provides a virtual desktop environment to a remote user in a server virtualization environment.

2. Description of Related Art

A client can use the resources of a server through a terminal service provided in a virtual desktop protocol in a server virtualization environment.

In this case, the type of virtual desktop protocol may include a remote desktop protocol (RDP), a remote frame buffer (RFB) protocol, a PC-over-IP protocol (PCoIP), or the like, depending on the operating system (OS). Herein, the remote desktop protocol (RDP) provides the terminal service called the remote desktop connection (RDC), the remote frame buffer (RFB) protocol provides the terminal service called virtual network computing (VNC), and the PC-over-IP protocol (PCoIP) provides the terminal service solution.

At this time, the internal structures for each operating system (OS) are different, and thus the implementations of the terminal services differ according to the type of virtual desktop protocol.

Therefore, when the terminal service is provided through the different virtual desktop protocols in a server virtualization environment in which a plurality of operating systems (OS) is mounted and operated, the load on the system may be increased with increased data traffic.

In addition, in order to provide an experience similar to that of using a local computer to a remote user using the terminal service, the output reaction time of the server to input from the client needs to be shortened. In this case, since large amounts of data are transmitted through a limited network bandwidth, the virtual desktop protocol includes a software acceleration function such as compression or the like so as to satisfy the delay time required by the client.

However, since the plurality of operating systems (OS) is operated using limited physical resources in the server virtualization environment, the server virtualization environment may increase the system load and cause paralysis of the server system according to the application of the terminal service, as compared with a single computer environment. In addition, the data compression, achieved through the use of software in the virtual desktop protocol, may incur a system load.

### SUMMARY OF THE INVENTION

An embodiment of the present invention is directed to an apparatus and a method for accelerating a virtual desktop for efficiently processing data while reducing the system load when the number of users increases in a server virtualization environment.

Other objects and advantages of the present invention can be understood by the following description, and will become apparent with reference to the embodiments of the present invention. Also, it will be obvious to those skilled in the art to which the present invention pertains that the objects and advantages of the present invention can be realized by the means as claimed and combinations thereof.

In accordance with an embodiment of the present invention, an apparatus for accelerating a virtual desktop includes a plurality of media processors, a processor, a transmission unit, and a transmission command pool. The plurality of media processors is used to process media data. The processor extracts data attribute information from virtual desktop acceleration commands for a client apparatus received from a host apparatus and transmits the virtual desktop acceleration commands to the plurality of media processors according to the attribute information. The transmission unit transmits results for the virtual desktop acceleration commands, which have been processed through the plurality of media processors, to the client apparatus. The transmission command pool transmits a complete signal, indicating that the processed results have been transmitted to the client apparatus, to the host apparatus.

In accordance with another embodiment of the present invention, a method for accelerating a virtual desk top processing virtual desktop data includes: receiving virtual desktop acceleration commands for a client from a host, extracting data attribute information from the virtual desktop acceleration command, generating processed results for the virtual desktop acceleration commands by processing the virtual desktop acceleration commands using a processor corresponding to the data attribute information among a plurality of processors, and transmitting the processed results to the client.

### BRIEF DESCRIPTION OF THE DRAWINGS

FIG. 1 is a diagram illustrating the configuration of a virtual desktop system in accordance with an exemplary embodiment of the present invention;

FIG. 2 is a diagram illustrating a method for providing a virtual desktop service in accordance with an exemplary embodiment of the present invention; and

FIG. 3 is a diagram illustrating a method for accelerating a virtual desktop in accordance with an exemplary embodiment of the present invention.

### DESCRIPTION OF SPECIFIC EMBODIMENTS

Exemplary embodiments of the present invention will be described below in greater detail with reference to the accompanying drawings. The present invention may, however, be embodied in different forms, and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

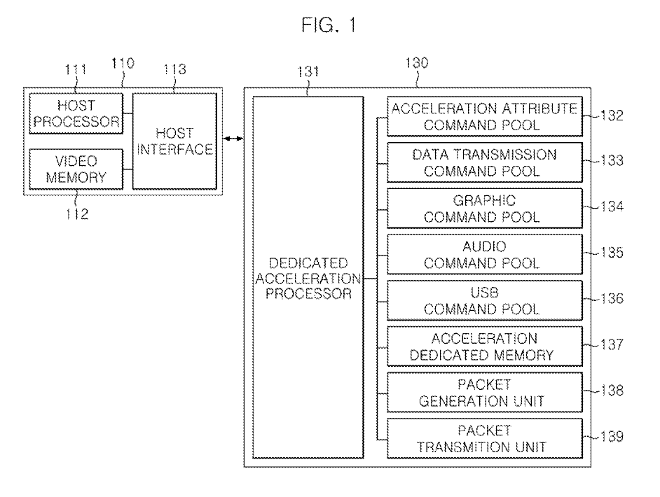

First, a virtual desktop system in accordance with an exemplary embodiment of the present invention will be described with reference to FIG. 1.

FIG. 1 is a diagram illustrating the configuration of a virtual desktop system in accordance with an exemplary embodiment of the present invention.

As illustrated in FIG. 1, a virtual desktop system includes a host apparatus 110 and an apparatus 130 for accelerating a virtual desktop.

The host apparatus 110 provides a virtual desktop environment to a client and includes a host processor 111, a video memory 112, and a host interface 113. In this configuration, the host apparatus 110 may provide a virtual desktop environment to the client by using the apparatus 130 for accelerating a virtual desktop according to an offloading scheme.

The host processor 111 processes a request from the client connected to the virtual desktop through the apparatus 130 for accelerating a virtual desktop and transmits the processed results to the client. In this case, the host processor 111 may allow the apparatus 130 for accelerating a virtual desktop to transmit the processed results directly to the client.

The host apparatus 110 stores data relating to video memory 112 graphics.

The host interface 113 is connected to the apparatus 130 for accelerating a virtual desktop and represents a programmable communication interface (hereinafter, referred to as ‘PCI’) or PCI express, which has been frequently used.

The apparatus 130 for accelerating a virtual desktop, which is an offloading apparatus for the host apparatus 110 for accelerating a virtual desktop, includes a dedicated acceleration processor 131, an acceleration attribute command pool 132, a data transmission command pool 133, a graphic command pool 134, an audio command pool 135, a USB command pool 136, a dedicated acceleration memory 137, a packet generation unit 138, and a packet transmission unit 139.

The dedicated acceleration processor 131 analyzes virtual desktop acceleration commands to extract data attribute information and transmits the corresponding commands to the graphic command pool 134, the audio command pool 135, or the USB command pool 136 to control data transmission and reception. In this case, the virtual desktop acceleration commands may have graphic attributes, audio attributes, or USB attributes.

The acceleration attribute command pool 132 stores the virtual desktop acceleration commands received from the host apparatus 110. Herein, the acceleration attribute command pool 132 is configured to include a register having a message queue type and a queue controller. Using the above configuration, the host processor 111 may download the commands to the apparatus for accelerating a virtual desktop and then perform other tasks.

The data transmission command pool 133 transmits the processed results for the virtual desktop acceleration commands to the host apparatus 110 according to the control of the dedicated acceleration processor 131 and extracts the virtual desktop data for processing the virtual desktop commands in the host apparatus 110. In this case, the data transmission command pool 133 is configured to include the register having the message queue type and the queue controller and may process the commands in the host processor 111 using the above-mentioned configuration as soon as the commands arrive.

The processed result transmission commands are stored, the processed results for the virtual desktop acceleration commands are transmitted to the host apparatus 110 according to the processing result transmission commands, and the virtual desktop data that is required to process the virtual desktop acceleration commands are fetched from the host apparatus 110.

The graphic command pool 134 processes the virtual desktop acceleration commands having the graphic attributes and stores the processed results in the dedicated acceleration memory 137. In this case, the graphic command pool 134 may include a graphic channel coding module, wherein the graphic channel coding module may use a compression method corresponding to quality of service (QoS) according to the transmission bandwidth of the network and the type of application program.

The audio command pool 135 processes the virtual desktop acceleration commands having the audio attributes and stores the processed results in the dedicated acceleration memory 137. The audio command pool 135 may include an audio channel coding and decoding module, wherein the audio channel coding and decoding module may use a compression method corresponding to the quality of service (QoS) according to the transmission bandwidth of the network and the type of application program.

The USB command pool 136 processes the virtual desktop acceleration commands having the USB attributes and stores the processed results in the dedicated acceleration memory 137.

The dedicated acceleration memory 137 stores the processed results for the virtual desktop acceleration commands. In this case, the dedicated acceleration memory 137 may store the processed results for each attribute of the virtual desktop acceleration commands. In addition, the dedicated acceleration memory 137 may store an identifier for the virtual desktop, a fetch address and a storage address for the processed results of the virtual desktop data, and a profile of the virtual desktop data. In this case, the dedicated acceleration memory 137 may rapidly perform data transmission through direct memory access (hereinafter, referred to as ‘DMA’).

The packet generation unit 138 generates packets including data stored in the dedicated acceleration memory 137 according to the predetermined protocol.

The packet transmission unit 139 transmits the generated packets to the client through the packet generation unit 138.

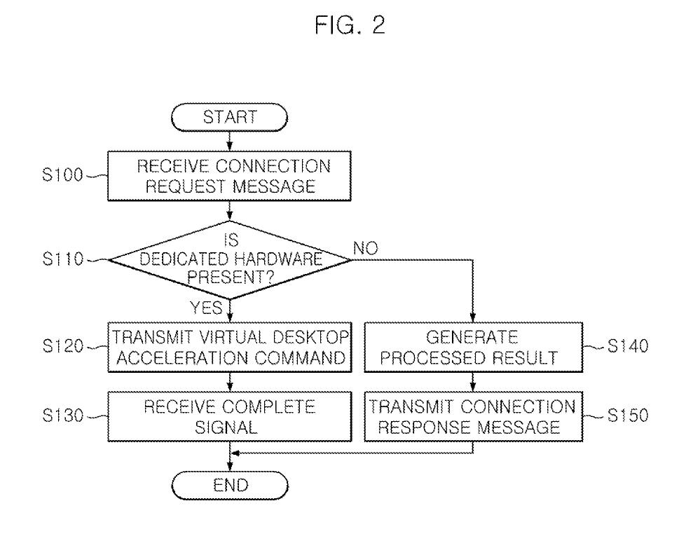

Next, the method for providing the virtual desktop service to the client by the host apparatus in accordance with the exemplary embodiment of the present invention will be described with reference to FIG. 2.

FIG. 2 is a diagram illustrating a method for providing a virtual desktop service in accordance with an exemplary embodiment of the present invention.

As illustrated in FIG. 2, first, the host apparatus 110 receives a connection request message corresponding to a virtual desktop connection request from the client (S100).

Next, the host apparatus 110 determines whether the apparatus 130 for accelerating a virtual desktop corresponding to a dedicated hardware is present, so as to improve the speed of the virtual desktop service (S110).

As the determination result at S110, if it is determined that the apparatus 130 for accelerating a virtual desktop is present, the host apparatus 110 transmits the virtual desktop acceleration commands to the apparatus 130 for accelerating a virtual desktop (S120).

Thereafter, the host apparatus 110 receives a complete signal for the virtual desktop acceleration commands, indicating that the processed results for the connection request message have been transmitted to the client from the apparatus 130 for accelerating a virtual desktop (S130).

As the determination result at S110, if it is determined that the apparatus 130 for accelerating a virtual desktop is not present, the host apparatus 110 generates the processed results for the connection request message through software processing (S140).

Next, the host apparatus 110 transmits a connection response message including the generated processed results to the client (S150).

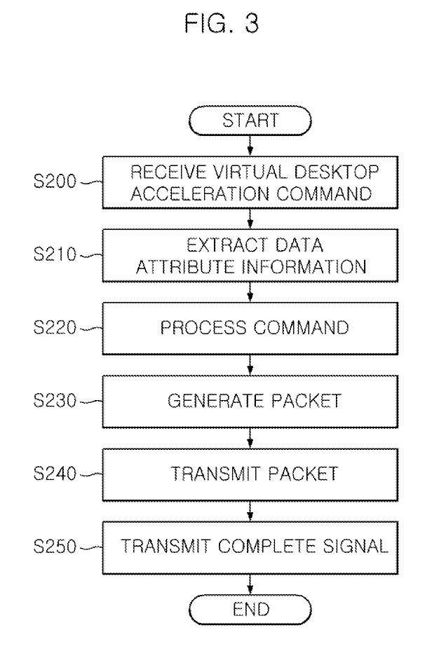

Next, a method for allowing the apparatus for accelerating a virtual desktop in accordance with the exemplary embodiment of the present invention to accelerate the virtual desktop will be described with reference to FIG. 3.

FIG. 3 is a diagram illustrating a method for accelerating a virtual desktop in accordance with an exemplary embodiment of the present invention.

As illustrated in FIG. 3, first, the apparatus 130 for accelerating a virtual desktop receives the virtual desktop acceleration commands from the host apparatus 110 (S200). In this case, the virtual desktop acceleration commands may include the virtual desktop data and the address information of the client.

Next, the apparatus 130 for accelerating a virtual desktop extracts the data attribute information from the virtual desktop acceleration commands through the dedicated acceleration processor 131 (S210). In this case, the virtual desktop acceleration commands may have graphic attributes, audio attributes, or USB attributes, depending on the data attribute information.

Thereafter, the apparatus 130 for accelerating a virtual desktop processes the virtual desktop acceleration commands according to the data attribute information to generate the processed results for the virtual desktop acceleration commands (S220). In this case, when the data attribute information has graphic attributes, the apparatus 130 for accelerating a virtual desktop may process the virtual desktop acceleration commands through the graphic command pool 134. Further, when the data attribute information has audio attributes, the apparatus 130 for accelerating a virtual desktop may process the virtual desktop acceleration commands through the audio command pool 135. Further, when the data attribute information has USB attributes, the apparatus 130 for accelerating a virtual desktop may process the virtual desktop acceleration commands through the USB command pool 136.

Next, the apparatus 130 for accelerating a virtual desktop generates packets including the processed results for the virtual desktop acceleration commands according to the predetermined protocol through the packet generation unit 138 (S230).

Thereafter, the apparatus 130 for accelerating a virtual desktop transmits the packets generated through the packet transmission unit 139 to the client (S240). In this case, the packet transmission unit 139 may use the address information of the client, including the virtual desktop acceleration commands, to transmit the generated packets to the client through the network.

Next, the apparatus 130 for accelerating a virtual desktop transmits a complete signal, indicating that the processing for the virtual desktop acceleration commands has been completed, to the host apparatus 110 through the data transmission command pool 133 (S250).

In accordance with the exemplary embodiment of the present invention, the load of the host apparatus can be reduced by processing the data in the apparatus for accelerating the virtual desktop, and the load of the host that provides the virtual desktop service can be reduced and the processing speed for the virtual desktop data can be improved by transmitting the data that have been previously prepared in the memory to the network by the simple offloading scheme when the data processing results are transmitted.

While the present invention has been described with respect to the specific embodiments, it will be apparent to those skilled in the art that various changes and modifications may be made without departing from the spirit and scope of the invention as defined in the following claims.

What is claimed is:

1. An apparatus for accelerating a virtual desktop, comprising:
a plurality of media processors configured to process media data;
a processor configured to extract data attribute information from virtual desktop acceleration commands for a client apparatus received from a host apparatus and transmit the virtual desktop acceleration commands to any one of the plurality of media processors according to the attribute information;
a transmission unit configured to transmit processed results for the virtual desktop acceleration commands processed through the plurality of media processors to the client apparatus; and
a transmission command pool configured to transmit a complete signal, indicating that the processed results are transmitted to the client apparatus, to the host apparatus.

2. The apparatus of claim 1, wherein the data attribute information includes graphic attribute information or audio attribute information.

3. The apparatus of claim 2, wherein any one of the plurality of media processors processes the virtual desktop acceleration commands including the graphic attribute information to generate the processed results.

4. The apparatus of claim 2, wherein any one of the plurality of media processors processes the virtual desktop acceleration commands including the audio attribute information to generate the processed results.

5. The apparatus of claim 1, wherein any one of the plurality of media processors processes the virtual desktop acceleration commands according to quality of service information.

6. The apparatus of claim 1, further comprising a packet generation unit configured to convert the processed results into a predetermined packet type.

7. The apparatus of claim 1, further comprising an attribute command pool configured to store a plurality of commands received from the host apparatus using a register.

8. A method for accelerating a virtual desktop processing virtual desktop data, comprising:
receiving virtual desktop acceleration commands for a client from a host;
extracting data attribute information from the virtual desktop acceleration command;
generating processed results for the virtual desktop acceleration commands by processing the virtual desktop acceleration commands using a processor corresponding to the data attribute information among a plurality of processors; and
transmitting the processed results to the client.

9. The method of claim 8, further comprising transmitting a complete signal, indicating that the processing for the virtual desktop acceleration commands is completed, to the host.

10. The method of claim 8, wherein the generating of the processed results processes the virtual desktop acceleration command using a graphic processor among the plurality of processors.

11. The method of claim 8, wherein the generating of the processed results processes the virtual desktop acceleration commands using an audio processor among the plurality of processors.

12. The method of claim 8, wherein the transmitting of the processed results converts the processed results into a predetermined packet type and transmits the converted processing results.
